(19) United States
(12) Patent Application Publication
(10) Pub. No.: US 2022/0081026 A1
(43) Pub. Date: Mar. 17, 2022

(54) ROTATION LIMITING DEVICE FOR STEERING SYSTEM

(71) Applicant: Steering Solutions IP Holding Corporation, Saginaw, MI (US)

(72) Inventors: John E. Weber, Pinconning, MI (US); Rodney M. Sanderson, Midland, MI (US)

(21) Appl. No.: 17/477,925

(22) Filed: Sep. 17, 2021

Related U.S. Application Data
(60) Provisional application No. 63/079,781, filed on Sep. 17, 2020.

(51) Int. Cl. B62D 5/04; B62D 5/00

(52) U.S. Cl. CPC B62D 5/0469; B62D 5/005; B62D 5/0403

(57) ABSTRACT

A rotation limiting device for a steering system includes a steering shaft rotatable during steering motion. The rotation limiting device also includes a stationary feature. The rotation limiting device further includes a first plate having a face defining a slot extending from a first end to a second end. The rotation limiting device yet further includes a second plate having a face defining a spiral shaped recess extending from a first spiral end to a second spiral end. The rotation limiting device also includes a ball bearing partially disposed within the spiral shaped recess and the slot, wherein one of the first plate and the second plate is fixed to the stationary feature, and the other of the first plate and the second plate is fixed to the steering shaft and rotatable therewith.

### CROSS REFERENCE TO RELATED APPLICATION

This patent application claims the benefit of priority to U.S. Provisional Patent Application Ser. No. 63/079,781 filed Sep. 17, 2020, the disclosure of which is incorporated by reference herein in its entirety.

### FIELD OF THE INVENTION

The present disclosure relates to a steering system and, more particularly, to a rotation limiting device for a steering system.

### BACKGROUND

In steering systems, limitation to a specified number of degrees of angular rotation of a steering shaft is desirable in many designs. Such systems may be included in automotive and marine steering applications. While prior systems have included rotation limiting features, they often have long axial profiles, are complicated to manufacture or assemble, and require numerous parts.

### SUMMARY

According to an aspect of the disclosure, a rotation limiting device for a steering system includes a steering shaft rotatable during steering motion. The rotation limiting device also includes a stationary feature. The rotation limiting device further includes a first plate having a face defining a slot extending from a first end to a second end. The rotation limiting device yet further includes a second plate having a face defining a spiral shaped recess extending from a first spiral end to a second spiral end. The rotation limiting device also includes a ball bearing partially disposed within the spiral shaped recess and the slot, wherein one of the first plate and the second plate is fixed to the stationary feature, and the other of the first plate and the second plate is fixed to the steering shaft and rotatable therewith.

According to another aspect of the disclosure, a rotation limiting device for a steering system includes a steering shaft rotatable during steering motion. The rotation limiting device also includes a housing for a portion of an electric steering system. The rotation limiting device further includes a first plate having a face defining a linearly extending slot extending from a first end to a second end. The rotation limiting device yet further includes a second plate having a face defining a non-linear recess extending from a first recess end to a second recess end. The rotation limiting device also includes a ball bearing partially disposed within the non-linear recess and the slot, wherein one of the first plate and the second plate is fixed to the housing, and the other of the first plate and the second plate is fixed to the steering shaft and rotatable therewith, wherein the length of the non-linear recess defines a limit of a degree of angular rotation for the steering shaft.

According to yet another aspect of the disclosure, a rotation limiting device for a steering system includes a steering shaft rotatable during steering motion. The rotation limiting device also includes a stationary feature. The rotation limiting device further includes a keeper pin coupled to the stationary feature. The rotation limiting device yet further includes a belt fixed at a first end to the keeper pin and surrounding the steering shaft at a second end.

These and other advantages and features will become more apparent from the following description taken in conjunction with the drawings.

### BRIEF DESCRIPTION OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a portion of an electric steering system;

FIG. 2 is a perspective, disassembled view of a rotation limiting device for the electric steering system according to one aspect of the disclosure;

FIG. 3 is an elevational view of the rotation limiting device of FIG. 2;

FIG. 4 is an elevational, cross-sectional view of the rotation limiting device of FIG. 2; and

FIG. 5 is a perspective view of the rotation limiting device according to another aspect of the disclosure.

### DETAILED DESCRIPTION

The embodiments described herein pertain to a steering system. The steering system is disposed in a marine vessel, but it is contemplated that other types of vehicles may benefit from the disclosed embodiments. By way of non-limiting example, such vehicles may include automobiles, snowmobiles, aircraft, ATVs, commercial delivery vehicles, etc. In the case of a marine vessel, any suitable marine vessel that requires manual steering may benefit from the disclosed embodiments. In some embodiments, the steering system includes an electric power steering system that assists an operator by lowering the required manual effort required to steer the marine vessel. Furthermore, the steering system may not have a continuous, mechanical connection along the entire steering column. Such a system is referred to as a steer-by-wire steering system.

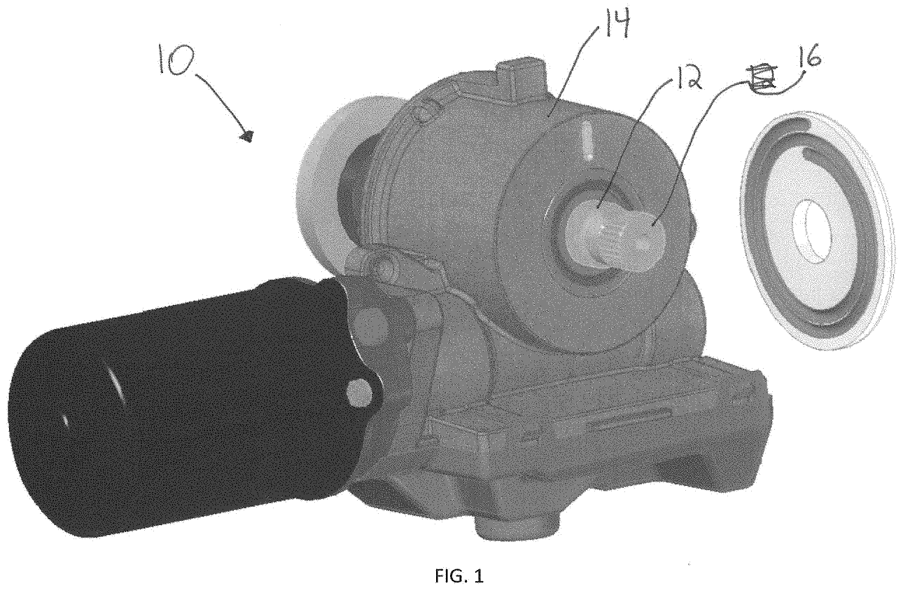

FIG. 1 illustrates an example of a portion of an electric steering system 10. The steering system 10 includes a steering mechanism (not shown), such as a hand wheel. The hand wheel may be disposed on a helm of the marine vessel or some other suitable location. The operator of the marine vessel engages the hand wheel in order to control steering of the marine vessel. The steering system 10 includes a propulsion mechanism (not shown) that includes a motor and a rudder. While only the motor and the rudder are described herein, it should be understood that the propulsion mechanism may include additional or fewer components than described herein. For example, the propulsion mechanism may include one or more motors, a propulsion engine, one or more rudders, one or more propellers, other suitable components, or a combination thereof.

The motor may include any suitable motor, such as an outboard motor, an inboard motor, and the like. The operator of the marine vessel may engage a throttle (not shown) disposed proximate the hand wheel to engage and/or control the motor. For example, the operator may increase or decrease a rotational velocity of a propeller associated with the motor by moving the throttle. Additionally, or alternatively, the operator may raise or lower the propeller of the motor using one or more switches disposed on the throttle or proximate the throttle.

The portion of the illustrated steering system 10 includes a shaft 12 that rotates in response to a steering input from an operator. The shaft 12 extends, at least partially, through a housing 14. The end 16 of the shaft 12 that is shown protruding outward of the housing 14 is configured to be coupled to the steering mechanism, such as a wheel, for example. The steering system 10 may be configured as a steer-by-wire system in some embodiments, such that the shaft 12 is not required to be mechanically coupled to other components that move the motor in the case of a marine vessel, or wheels in the case of an automobile or the like.

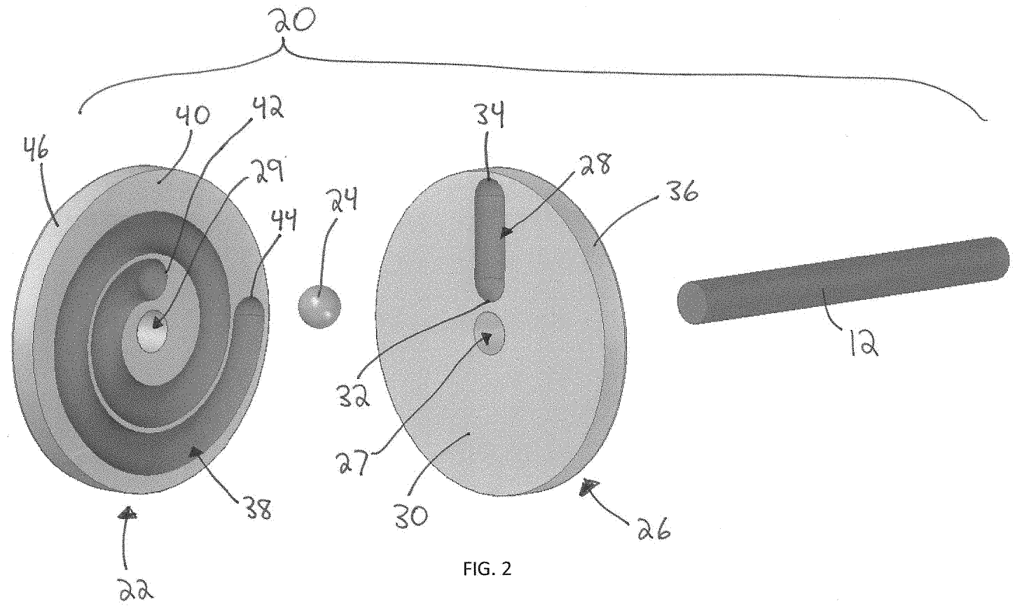

FIGS. 2-4 illustrate a first embodiment of a rotation limiting device 20. The device utilizes a fixed plate 22, a ball bearing 24, and a rotating plate 26. The rotating plate 26 defines a hole 27 for receiving the (steering) shaft 12 through it. Similarly, the fixed plate 22 defines a hole 29 for receiving the shaft 12 therethrough. The rotating plate 26 is fixed to the shaft 12 in a manner that results in corresponding rotation of the rotating plate 26 and the shaft 12. As will be appreciated herein, the rotation limiting device 20 is configured to limit the rotation of the shaft 12 to a desired number of degrees of rotation.

According to the embodiment of FIGS. 2-4, the rotating plate 26 has a radially extending slot 28 defined on a mating face 30 of the rotating plate 26. The slot 28 is a recess in the rotating plate 26 that is sized to accommodate the ball bearing 24 therein. The slot 28 is dimensioned such that the ball bearing 24 is able to translate along the slot 28 in a substantially radially outward direction, i.e. a longitudinal direction of the slot 28. The slot 28 extends from a first end 32 to a second end 34. The first end 32 is located radially outward from the center of the rotating plate 26, such that the slot 28 begins radially offset from the center of the rotating plate 26. In the illustrated embodiment, the hole 27 that receives the shaft 12 therethrough is centrally located on the rotating plate 26, with the first end 32 of the slot 28 being offset therefrom. The second end 34 of the slot 28 is located radially inwardly of the outer diameter surface 36 of the rotating plate 26.

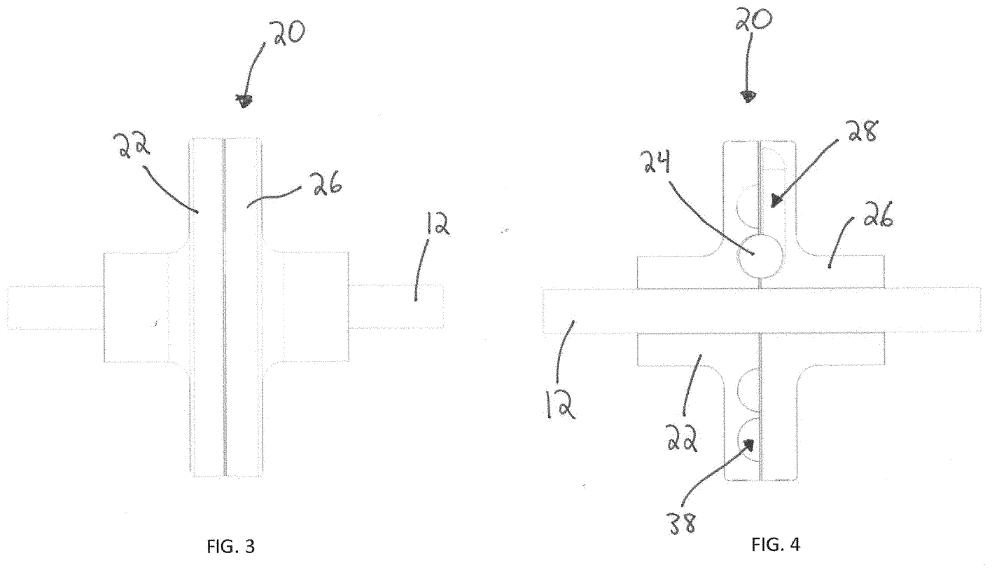

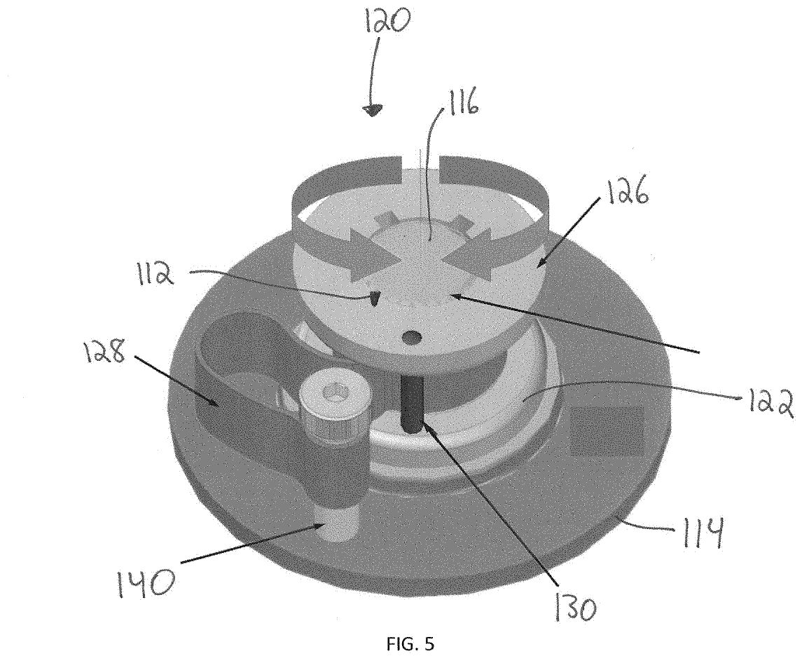

The fixed plate 22 has a spiral shaped recess 38 defined within a mating face 40 of the fixed plate 22. The mating face 40 of the fixed plate 22 and the mating face 30 of the rotating plate 26 face each other in an assembled condition, such that at least a portion of the mating faces 30, 40 are either in abutment with each other or located in close proximity to each other in the assembled condition, as shown well in FIGS. 3 and 4.

The spiral shaped recess 38 extends continuously from a first spiral end 42 to a second spiral end 44. The spiral shaped recess 38 defines a spiral that is centered about a center of the fixed plate 22. The spiral shaped recess 38 is a recess in the fixed plate 22 that is sized to accommodate the ball bearing 24 therein. The spiral shaped recess 38 is dimensioned such that the ball bearing 24 is able to move along the spiral shaped recess 38 in the spiral path defined by the recess 38. The first spiral end 42 is located radially outward from the center of the fixed plate 22, such that the recess 38 begins radially offset from the center of the fixed plate 22. In the illustrated embodiment, the hole 29 that receives the shaft 12 therethrough is centrally located on the fixed plate 22, with the first spiral end 42 of the recess 38 being offset therefrom. The second spiral end 44 of the recess 38 is located radially inwardly of the outer diameter surface 46 of the fixed plate 22.

The fixed plate 22 and the rotating plate 26 are axially aligned on the steering shaft 12 with the above-described slot 28 and recess 38 facing each other, and timed so as to allow the ball bearing 24 to be placed within each. The plates 22, 26 are then brought together to sandwich the ball bearing 24 in place, yet still allow relative rotation of the plates 22, 26. The fixed plate 22 is fixed to the housing 14 or some other stationary feature, while the rotating plate 26 is attached to the steering shaft 12, as described above. The rotating plate 26 rotates with the steering shaft 12. During such rotation, the ball bearing 24 will translate along the path of the slot 28 until the ball bearing 24 seats against the second spiral end 44 of the spiral shaped recess 38. By controlling the length (number of revolutions) of the spiral shaped recess 38, the number of revolutions (degrees) of shaft rotation can be controlled.

While described above as having the plate with the substantially linear slot 28 fixed to the steering shaft 12 and rotatable, it is to be appreciated that the plate with the spiral shaped recess 38 may be the plate that is fixed to the steering shaft 12, therefore being the rotating plate. Additionally, a plurality of plates could be stacked together with multiple plates defining a spiral shaped slot to allow for a greater number of revolutions of travel (e.g., angular degrees) for the shaft 12.

Referring now to FIG. 5, a rotation limiting device according to another aspect of the disclosure is illustrated and is generally referenced with numeral 120. The rotation limiting device 120 of FIG. 5 includes a housing or other fixed structure 114, which may correspond to the housing 14 illustrated in FIG. 1. As with FIG. 1, a shaft 112 that rotates in response to a steering input from an operator extends through the housing 114, with an end 116 of the shaft 112 protruding through the housing 114, as illustrated. The rotation limiting device 120 may be part of a steer-by-wire system in some embodiments, such that the shaft 112 is not required to be mechanically coupled to other components that move the motor in the case of a marine vessel, or wheels in the case of an automobile or the like.

A fixed plate 122 is attached to an end of the housing 114. A rotating plate 126 is coupled to the end 116 of the shaft 112 in a manner that facilitates corresponding rotation of the rotating plate 126 and the shaft 112. The coupling of the rotating plate 126 and the shaft 112 may be carried out in any suitable manner. For example, the rotating plate 126 may be secured to the shaft 112 with a key, pin, whistle notch, spline, etc. The preceding coupling processes/structures are merely non-limiting examples and are not intended to be exhaustive.

While the shaft 112 extends through respective apertures of both the fixed plate 122 and the rotating plate 126, the housing 114 and the fixed plate 122 do not rotate with the shaft 112, as the rotating plate 126 does. In the illustrated embodiment, the apertures that the shaft 112 extend through are substantially centrally located on the plates 122, 126.

A winding pin 130 is coupled to the rotating plate 126 and extends into abutment or close proximity to the fixed plate 122. Upon rotation of the rotating plate 126, the winding pin 130 rotates with the plate 126 and slides along the fixed plate 122. The winding pin 130 is mounted to the rotating plate 126 radially outwardly of the shaft 112 position. A belt 128 is wrapped around the outer diameter of the shaft 112. It is to be understood that the belt 128 may be alternative structures, such as a strap, cable, string or a similar member. The belt 128 is looped loosely around this outer diameter, but radially inwardly of the winding pin 130. This allows one revolution with no take-up of the belt 128. This reduces the belt length by one circumferential distance. A keeper pin 140 fixes the other end of the belt 128 to the non-rotating portion of the rotary device, such as to the housing 114. As with the device of FIGS. 2-4, by controlling the length (number of revolutions) of the belt 128, the number of revolutions (degrees) of shaft rotation can be controlled.

In another embodiment of FIG. 5, the rotating plate 126 is part of a uniform structure that includes the fixed plate, but the entire structure is rotatable relative to the housing 114. In such an embodiment, the winding pin 130 is coupled to both plates and the entire structure rotates together to bias the belt 128 and ultimately limit rotation of the shaft 112.

The rotation limiting devices disclosed herein provide end of travel stops in steering systems. This may be especially beneficial for steer-by-wire applications, where there may not be any mechanical connection to the steering linkage/wheels. These devices will provide the lock-to-lock feel and also limit over-travel of the steering wheel. These devices could also be utilized for video game steering systems to provide benefits.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

What is claimed is:

1. A rotation limiting device for a steering system comprising:
a steering shaft rotatable during steering motion;
a stationary feature;
a first plate having a face defining a slot extending from a first end to a second end;
a second plate having a face defining a spiral shaped recess extending from a first spiral end to a second spiral end; and
a ball bearing partially disposed within the spiral shaped recess and the slot, wherein one of the first plate and the second plate is fixed to the stationary feature, and the other of the first plate and the second plate is fixed to the steering shaft and rotatable therewith.

2. The rotation limiting device of claim 1, wherein the first end of the first plate and the first spiral end of the second plate are radially outward of a center location of each plate.

3. The rotation limiting device of claim 2, wherein the steering shaft extends through central apertures of the first plate and the second plate.

4. The rotation limiting device of claim 1, wherein the slot of the first plate extends in a linear direction.

5. The rotation limiting device of claim 1, wherein the stationary feature is a housing for a portion of an electric steering system.

6. The rotation limiting device of claim 5, wherein the electric steering system is a steer-by-wire system.

7. The rotation limiting device of claim 5, wherein the electric steering system is disposed in one of a marine vessel, an automobile, a snowmobile, an aircraft, an ATV, and a commercial delivery vehicle.

8. The rotation limiting device of claim 1, wherein the length of the spiral shaped recess defines a limit of a degree of angular rotation for the steering shaft.

9. The rotation limiting device of claim 8, further comprising one or more additional plates, each of the additional plates defining an additional recess to increase the limit of the degree of angular rotation for the steering shaft.

10. The rotation limiting device of claim 1, wherein the second spiral end of the spiral shaped slot and the second end of the slot are located radially inwardly of an outer diameter of their respective plates.

11. A rotation limiting device for a steering system comprising:
a steering shaft rotatable during steering motion;
a housing for a portion of an electric steering system;
a first plate having a face defining a linearly extending slot extending from a first end to a second end;
a second plate having a face defining a non-linear recess extending from a first recess end to a second recess end; and
a ball bearing partially disposed within the non-linear recess and the slot, wherein one of the first plate and the second plate is fixed to the housing, and the other of the first plate and the second plate is fixed to the steering shaft and rotatable therewith, wherein the length of the non-linear recess defines a limit of a degree of angular rotation for the steering shaft.

12. The rotation limiting device of claim 11, further comprising one or more additional plates, each of the additional plates defining an additional recess to increase the limit of the degree of angular rotation for the steering shaft.

13. The rotation limiting device of claim 11, wherein the electric steering system is a steer-by-wire system.

14. The rotation limiting device of claim 11, wherein the electric steering system is disposed in one of a marine vessel, an automobile, a snowmobile, an aircraft, an ATV, and a commercial delivery vehicle.

15. A rotation limiting device for a steering system comprising:
a steering shaft rotatable during steering motion;
a stationary feature;
a keeper pin coupled to the stationary feature; and
a belt fixed at a first end to the keeper pin and surrounding the steering shaft at a second end.

16. The rotation limiting device of claim 15, further comprising:
a rotatable member coupled to the steering shaft and rotatable therewith; and
a winding pin coupled to the rotatable member and rotatable therewith, the winding pin located radially outwardly of the belt.

17. The rotation limiting device of claim 16, wherein the stationary feature is a housing for a portion of an electric steering system.

18. The rotation limiting device of claim 17, wherein the electric steering system is a steer-by-wire system.
